(19) United States
(12) Patent Application Publication
(10) Pub. No.: US 2021/0040394 A1
(43) Pub. Date: Feb. 11, 2021

(54) DILUTED BITUMEN FINE WATER DROPLETS CAPTURE

(71) Applicant: SYNCRUDE CANADA LTD. in trust for the owners of the Syncrude Project as such owners exist now and in, Calgary (CA)

(72) Inventors: BRIAN KNAPPER, Edmonton (CA); DENA ROSSITER, Edmonton (CA); SUJIT BHATTACHARYA, Edmonton (CA)

(21) Appl. No.: 16/987,006

(22) Filed: Aug. 6, 2020

Related U.S. Application Data
(60) Provisional application No. 62/884,533, filed on Aug. 8, 2019.

(51) Int. Cl. C10G 1/04; B01D 21/00; B01D 21/26; B04B 1/04; B01D 17/04; B03B 9/02; B03D 1/14; B03D 1/08

(52) U.S. Cl. CPC C10G 1/047; B01D 21/0042; B01D 21/262; B04B 1/04; B01D 21/267; B03D 2203/006; B03B 9/02; B03D 1/1418; B03D 1/082; C10G 2300/4075; C10G 2300/802; B01D 17/047

(57) ABSTRACT

A method for processing bitumen froth comprised of bitumen, water containing chlorides and solids is provided for producing a final diluted bitumen product having reduced chlorides. In particular, fine water droplets containing chlorides that are present in raw diluted bitumen are captured by washing the raw diluted bitumen with low salinity water to produce the final diluted bitumen product having reduced chlorides.

### FIELD OF THE INVENTION

The present invention relates generally to a method for processing bitumen froth to produce a diluted bitumen product having reduced chloride content. In particular, the invention is related to water washing a diluted bitumen froth to capture fine water droplets that can subsequently be removed by conventional means.

### BACKGROUND OF THE INVENTION

Natural oil sand is a complex mixture of sand, water, clay fines and bitumen. A typical composition of oil sand is 10 wt % bitumen, 5 wt % water and 85 wt % solids. Water based extraction processes are used to extract the bitumen from oil sand to produce an extraction product that is referred to in the industry as “bitumen froth”. Generally, bitumen froth quality produced from bitumen extraction has a composition of ˜60 wt % bitumen, ˜30 wt % water and ˜10 wt % solids. Examples of bitumen extraction processes include the Clark Hot Water Process, a warm water extraction process as described in Canadian Patent No. 2,029,795, and a low energy process as described in Canadian Patent No. 2,217,623.

Unfortunately, the extraction product (i.e., bitumen froth) is not suitable to feed directly to bitumen processing/upgrading plants. A typical bitumen froth comprises about 60 wt % bitumen, 30 wt % water and 10 wt % solids. Hence, the bitumen froth needs to be first treated before it is suitable for further upgrading. Such treatment is referred to in the industry as “froth treatment”. The primary purpose of froth treatment is to remove the water and solids from the bitumen froth to produce a clean diluted bitumen product (i.e., “diluted bitumen” or “dilbit”) which can be further processed to produce a fungible bitumen product that can be sold or processed in downstream upgrading units. There are two main types of froth treatment used in the industry today; a naphtha-based froth treatment and a paraffinic-based froth treatment.

Naphtha-based froth treatment processes generally use gravity and centrifugal separation technology. Naphtha is a solvent that is used to change the hydrocarbon viscosity and density properties such that it is more amenable to mechanical separation. Naphtha-based froth treatment processes can supply a high quality diluted bitumen product to the bitumen processing plants while minimizing hydrocarbon losses in the tailings. In naphtha-based froth treatment, naphtha is added to the bitumen froth (which is typically stored in froth tanks) generally at a diluent/bitumen ratio (wt./wt.) of about 0.4-1.0, preferably around 0.7, and then the diluted bitumen froth (“dilfroth”) is subjected to gravity separation (gravity-based method) or centrifugal separation (centrifuge-based method) to separate the bitumen from the water and solids.

In centrifugal separation, separation of the bitumen from water and solids may be done by treating the dilfroth in a series of scroll and/or disc stack centrifuges. Alternatively, the dilfroth may be subjected to gravity separation in a series of inclined plate separators (“IPS”) in conjunction with countercurrent solvent extraction using added naphtha diluent, followed by disc stack centrifugation. The resultant diluted bitumen products (“dilbit”) generally contain between about 0.5 to 0.8 wt. % solids and about 2-2.5 wt. % water.

For low salinity oil sand ore, e.g., oil sand ore having between about 50-100 ppm chlorides, having 2-2.5 wt % water in the dilbit is sufficiently low to meet the industry standard of 25 ppm chlorides in dry bitumen for upgrading (which corresponds to <15 ppm chloride in the diluted bitumen product obtained when using a naphtha to bitumen ratio of 0.7). As used herein, “dry bitumen” refers to the bitumen product from Diluent Recovery Units after naphtha, water, and light gas oil portions of the dilbit have been removed using atmospheric distillation. The chlorides in oil sand ore is found in the connate water associated with the oil sand, which, assuming approximately 5% water in ore, corresponds to a concentration of chlorides in the connate water of between about 1000-2000 ppm. Additional chlorides are also introduced into bitumen froth (and, ultimately, dilbit) from the recycled process water that is used during water-based bitumen extraction. Presently the process water used for extraction has about 600 ppm chlorides.

However, as higher salinity oil sand ores are mined and processed, e.g., oil sand ore having between about 750-850 ppm chlorides and sometimes as high as 1000 ppm, both the concentration of chlorides in the connate water and the subsequently produced process water produced will rise. It is estimated that 5-25% of the water in the final diluted bitumen product comes from the connate water and the other 75-95% of the chlorides come from the process water. Thus, it is estimated that with high salinity ores, the connate water will average 15,000-17,000 ppm and up to 20,000 ppm and the resultant process water will increase to 1200 ppm. This will result in a much higher chlorides content in the final diluted bitumen product.

It has been shown that the chloride content in dry bitumen is directly related to the water content in diluted bitumen product (dilbit). Thus, higher amounts of water in dilbit can lead to higher amounts of chlorides in dry bitumen. The chlorides are deposited as fine salts in the bitumen as the water is vapourized in the diluent recovery stage. During upgrading of dry bitumen, these salts inevitably hydrolyze at high temperatures in the presence of steam to become hydrochloric acid, which causes high rates of corrosion throughout upgrading. Undetected hydrochloric acid corrosion can result in major upgrading process upsets.

Thus, reducing the water content in dilbit becomes even more critical when mining an oil sand ore that has much saltier connate water (i.e., ores having a very high inorganic chlorides concentration). It is expected that some oil sand ore deposits will have such a high salinity that it is anticipated that the dilbit water content will need to be reduced to 1 wt. % or less to meet the industry standard of 25 ppm chloride in dry bitumen. However, with current bitumen froth treatment regimes, it is not possible to produce dilbit with such reduced water content.

Accordingly, there is a need in the industry for a bitumen froth treatment method that consistently produces a final diluted bitumen product with sufficiently low water content to meet the dry bitumen chloride target of about 25 ppm.

### SUMMARY OF THE INVENTION

The present applicant has discovered that naphtha-diluted bitumen froth contains a significant amount of fine water droplets, i.e., sub-micron droplets, which are difficult to remove using conventional disc stack centrifuges. For example, the Alfa Laval 320 disc centrifuge removes ˜99% of droplets ≥10 μm and ˜95% of droplets ≥5 μm. Droplet sizes below 5 μm, and, in particular, below 1 μm are beyond the removal capabilities of the current technology. These sub-micron droplets make their way through froth treatment and have been estimated to make up approximately 1 to 1.5 wt. % of the total 2.5 wt. % water in the diluted bitumen product (dilbit). Historically, the focus has been to use a demulsifier or an electrostatic coalescer to grow these sub-micron droplets for removal.

It was surprisingly discovered, however, that mixing low salinity water with raw diluted bitumen produced after a first separation stage, preferably, using high intensity mixing, prior to a final disc stack centrifuge separation step resulted in forced contact between the fresh water and sub-micron water droplets, thereby capturing the fine droplets which can be subsequently removed in disc centrifuges. Thus, adding a water washing stage into a conventional naphtha-based bitumen froth treatment process resulted in the production of a diluted bitumen product (dilbit) having a reduced chloride content of about 90% or greater.

In one aspect, a method for processing bitumen froth comprised of bitumen, water containing chlorides and solids to produce a final diluted bitumen product having a reduced chlorides content is provided, comprising:
adding a sufficient amount of a naphtha diluent to the bitumen froth to form a diluted bitumen froth;
subjecting the diluted bitumen froth to a first separation stage to separate a portion of the water and solids from the diluted bitumen froth to form a raw diluted bitumen;
adding a sufficient amount of low salinity water to the raw diluted bitumen and subjecting the raw diluted bitumen to a mixing stage;
optionally, adding a sufficient amount of a demulsifier to the raw diluted bitumen after the mixing stage; and
subjecting the raw diluted bitumen to a second separation stage to produce the final diluted bitumen product having reduced chloride.
   In one embodiment, the first separation stage comprises a gravity separation vessel such as an inclined plate settler. In one embodiment, the first separation stage comprises a centrifuge such as a decanter centrifuge. In one embodiment, the second separation stage comprises a centrifuge such as a disc stack centrifuge. In one embodiment, the first separation stage comprises at least one hydrocyclone.

In one embodiment, the mixing stage is a high intensity mixing stage. In one embodiment, the mixing stage comprises an inline shear mixer. In one embodiment, the mixing stage comprises a tank having an impeller.

In one embodiment, there is about a 90% or greater reduction in chlorides in the final diluted bitumen product.

In one embodiment, the mixing stage imparts a specific energy dissipation of at least 2 kW/m³ or greater, and preferably 20 kW/m³ or greater. In one embodiment, the mixing stage imparts a specific energy dissipation of between about 2 kW/m³ to 20 kW/m³. Mixing devices such as mixing tanks and inline static or dynamic mixers can provide specific energy dissipation in this range. It is understood, however, that there are other commercial devices such as high shear rotor-stator mixers that are also available that can impart specific energy dissipations that are significantly higher, i.e., higher than 20 kW/m³.

In one embodiment, the dosage of demulsifier ranges up to about 50 ppm. In one embodiment, the demulsifier content is in the range of about 1 ppm to about 50 ppm.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawing:

FIG. 1 is a schematic of an embodiment of a method for processing bitumen froth according to the present invention.

FIG. 2 is a graph showing the water droplet size distribution present in a diluted bitumen product with 2.5 wt. % water obtained using a prior art bitumen froth treatment method.

FIG. 3A is a graph showing the relative chlorides captured [% rel] versus water wash ratios [w/w] using the bitumen froth treatment method of the present invention.

FIG. 3B is a graph showing the relative chlorides captured [% rel] versus relative mixing energy (ε/εₘₐₓ) using the bitumen froth treatment method of the present invention.

FIG. 4 is a graph showing the chloride removal efficiency [1−Cl_{f}/Clₒ] versus water:dilbit addition ratio [w/w] using the bitumen froth treatment method of the present invention with deionized water and process water.

FIG. 5 is a graph showing the chloride content of diluted bitumen product [ppm] versus water:dilbit addition ratio [w/w] using the bitumen froth treatment method of the present invention with deionized water and process water.

### DETAILED DESCRIPTION OF PREFERRED EMBODIMENTS

The detailed description set forth below in connection with the appended drawing is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practised without these specific details.

The present invention relates generally to a method for processing bitumen froth to produce a diluted bitumen product having reduced chlorides. In order to be suitable for further processing (upgrading) to produce an acceptable bitumen product quality, it is desirable for the dry bitumen product to have less than about 25 ppm chlorides. Because oil sand ore can have a wide range of salt concentrations (chlorides), it is necessary to have a method that can consistently deliver such a dry bitumen product.

As used herein, the term “gravity-based” froth treatment method refers to an operation in which diluted bitumen is first subjected to a first separation stage to separate water and solids from the bitumen using gravity to produce a first product, “raw diluted bitumen”, and is therefore distinguished from other separation operations such as molecular sieve processes, absorption processes, adsorption processes, magnetic processes, electrical processes, and the like. As used herein, the term “gravity settler” refers to any suitable apparatus which facilitates gravity settling including, but not limited to, a gravity settling vessel and an inclined plate separator (“IPS”). As used herein, the term “IPS” refers to an apparatus comprising a plurality of stacked inclined plates onto which a mixture to be separated may be introduced so that the mixture passes along the plates in order to achieve separation of components of the mixture. Following the first separation stage, the raw diluted bitumen is then subjected to a second separation stage using a centrifuge such as a disc centrifuge to produce the final diluted bitumen product.

As used herein, the term “centrifuge-based” froth treatment method refers to an operation in which bitumen is first separated from water and solids to produce “raw diluted bitumen” using centrifugal acceleration or centripetal acceleration resulting from rotational movement of a suitable apparatus including, but not limited to, a scroll centrifuge, disc centrifuge, hydrocyclone, propelled vortex separator, and the like. The raw diluted bitumen is then subjected to a second separation stage using a centrifuge such as a disc centrifuge to produce the final diluted bitumen product.

As used herein, “high intensity mixing” means mixing at an intensity that provides a specific energy dissipation of at least about 2 kW/m³ or greater, and preferably 20 kW/m³ or greater.

As used herein, “fine water droplet” means a water droplet having a diameter of less than 10 μm. As used herein, “sub-micron water droplet” refers to water droplets having a diameter of less than 1 μm.

As used herein, the term “demulsifier” refers to an agent which breaks emulsions or causes water droplets either to coalesce and settle, or to flocculate and settle in flocs. Demulsifiers are commonly formulated from the following types of chemistries: polyglycols and polyglycol esters, ethoxylated alcohols and amines, ethoxylated resin, ethoxylated phenol formaldehyde resins, ethoxylated nonylphenols, polyhydric alcohols, ethylene oxide, propylene oxide block copolymer fatty acids, fatty alcohols, fatty amine and quaternaries and sulfonic acid salts.

As used herein, “low salinity water” means water having a chloride content of less than 600 ppm, preferably less than 400 ppm, and even more preferably chloride-free.

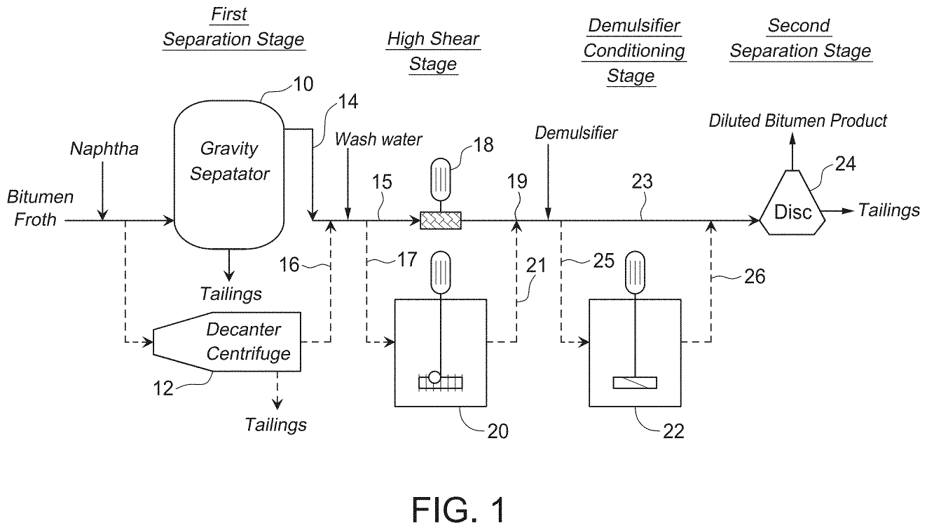

FIG. 1 is a general schematic of an embodiment of the present invention. The solid lines refer to a gravity-based froth treatment method and the hatched lines refer to a centrifuge-based froth treatment method. Bitumen froth is initially received from an extraction facility which extracts bitumen from oil sand using a water based extraction process known in the art. Naphtha is added to bitumen froth, generally, at a ratio of naphtha solvent to bitumen (by wt. %) from about 0.3 to about 1.0, preferably around 0.7 wt. %. The naphtha-diluted bitumen froth (dilfroth) is then the subjected to a first separation stage. In one embodiment, the dilfroth is separated in at least one gravity separation vessel 10, such as an inclined plate settler, to yield a product stream comprising raw diluted bitumen (stream 14) and at least one by-product stream comprising water and solids, namely tailings.

Low salinity wash water is then added to the raw diluted bitumen 14 and the mixture (stream 15) is then subjected to a high mixing intensity stage, for example, by mixing stream 15 in an in-line mixer 18, thereby forcing contact between the wash water and the fine water droplets present in the raw diluted bitumen 14. The high shear stage, while allowing the capture of the fine water droplets in the raw diluted bitumen, it also causes emulsions to form. These emulsions can be readily addressed by subjecting the sheared mixture 19 to a demulsifier conditioning stage by adding a demulsifier to the sheared mixture 19 to produce demulsifier treated stream 23. Stream 23 is then subjected to a second separation stage, for example, using a disc stack centrifuge 24, to produce the final diluted bitumen product and tailings.

In another embodiment, the first separation stage comprises using at least one decanter centrifuge 12 to yield a product stream comprising raw diluted bitumen (stream 16) and at least one by-product stream comprising water and solids, namely tailings. Low salinity wash water is then added to the raw diluted bitumen 16 and the mixture (stream 17) is then subjected to a high-intensity mixing, for example, by mixing stream 17 in an impeller tank 20, thereby forcing contact between the wash water and the fine water droplets present in the raw diluted bitumen 16. Once again, high intensity mixing causes emulsions to form so the sheared mixture 21 is next subjected to a demulsifier conditioning stage by adding a demulsifier to produce a first demulsifier treated stream 25.

In this embodiment, first demulsifier treated stream 25 is then subjected to mixing in an impeller tank 22 prior to being subjected to a second separation stage, for example, using a disc stack centrifuge 24 to produce the final diluted bitumen product and tailings. In both embodiments (gravity-based and centrifuge-based), the final diluted bitumen product is generally transferred to a diluent recovery unit (not shown) where naphtha is recovered, recycled and reused. The bitumen may be further treated in a fluid coker or ebullating-bed hydrocracker (“LC-Finer”) and may be further processed into a synthetic crude oil product by means not shown but disclosed in the art.

### Example 1

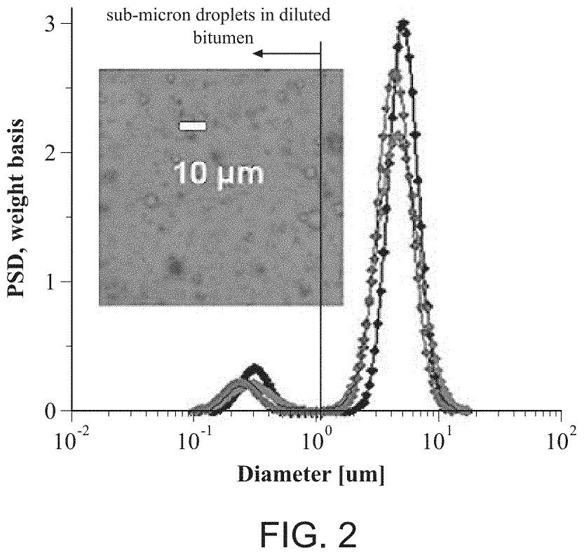

The water droplet sizes in a diluted bitumen product having 2.5% water, which were produced using conventional bitumen froth treatment, were measured in triplicate and the particle size distribution (PSD) of the various water droplet sizes, determined on a weight basis. FIG. 2 shows a graph which plots PSD, weight basis, against the diameter [μm] of the water droplets. It can be seen that the sub-micron water droplets make up between about 1 to 1.5% of the total 2.5% water. As mentioned, water droplets below about 5 μm, in particular, below 1 μm are beyond the removal capabilities of the current technology.

### Example 2

Batch tests were conducted to determine the effect of adding low salinity water (in this case, distilled water) on chlorides capture. A paint shaker was used for high intensity mixing at room temperature. It was found that 96.0±3.0% of the chlorides present in diluted bitumen having from 8 ppm to 516 ppm chlorides were removed. The chloride-rich water was easily separated from the hydrocarbon by adding 50 ppm demulsifier (Emulsotron X-2105 manufactured by Nalco-Champion) followed by room temperature centrifugation at 1000 g-force.

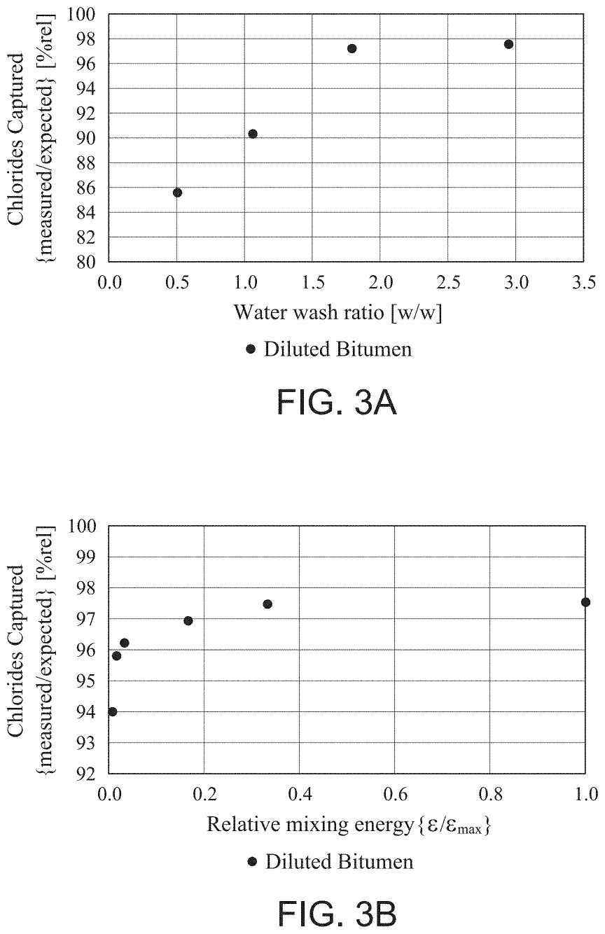

FIG. 3A shows the percent chlorides captured for various wash water ratios, i.e., water:dilbit [wt/wt], using diluted bitumen from a commercial froth treatment process having 16 ppm chloride. It can be seen from FIG. 3A that a water wash ratio of 2.0 [w/w] resulted in close to 100% capture of chlorides present in the diluted bitumen. FIG. 3B plots the percent chlorides captured [% rel] versus the relative mixing energy (ε/εₘₐₓ) of the water/diluted bitumen mixture having 16 ppm chlorides at a water wash ratio of 3.0. The relative mixing energy values, lowest to highest, correspond to mixing times of 0.25, 0.5, 1, 5, 10 and 30 minutes on the paint shaker, which gives a vigorous energy input. It can be seen that chlorides capture increased relative to the relative mixing energy, i.e., length of time on the paint shaker.

### Example 3

Further tests were performed using raw diluted bitumen and a serrated blade impeller in a tank for high-intensity mixing with wash water to extract chlorides from the raw diluted bitumen. The water:raw dilbit ratio was varied from 0.20 to 1.0 [wt/wt] and the chloride removal efficiency [1−Cl_{f}/Clₒ], where Cl_{f} is the final chloride concentration and Clₒ is the original chloride concentration, was determined. The tests were performed at a temperature of 80° C. and deionized water (DI) (having 0 ppm chlorides) and process water (PW) having a chloride concentration of 400 ppm were used as the wash water.

The raw diluted bitumen used in the tests was prepared using a bench-top froth treatment pilot plant. Bitumen froth produced from a high salinity oil sand ore was first mixed with naphtha in a mixing tank. The mixed product was then subjected to a first separation stage using a gravity separator for an extended duration (e.g., a residence time of about 40 minutes) to produce raw diluted bitumen with a target N:B ratio of 0.7. The raw diluted bitumen produced had a chloride content of 70 ppm, which is typical of the raw dilbit produced from a high salinity oil sand ore. Following the washing stage, 50 ppm demulsifier having the tradename Emulsotron X-2105 (manufactured by Nalco-Champion) was added to each sample and the samples were mixed at 2300 RPM for 10 minutes (in the tank having a serrated blade impeller). The samples were then centrifuged in an 80° C. “hot spin” for 6 minutes at 1400 RPM (about 160 g-force at diluted bitumen sampling location) to resolve the emulsion. The top 3 mL of the hydrocarbon from each centrifuge tubes were removed and combined in a 250 mL Nalgene bottle to produce a 20 g sample for chloride analysis using ion chromatography; triplicate 1 gram samples were taken from the paint-shaker sample for Karl Fischer water analysis.

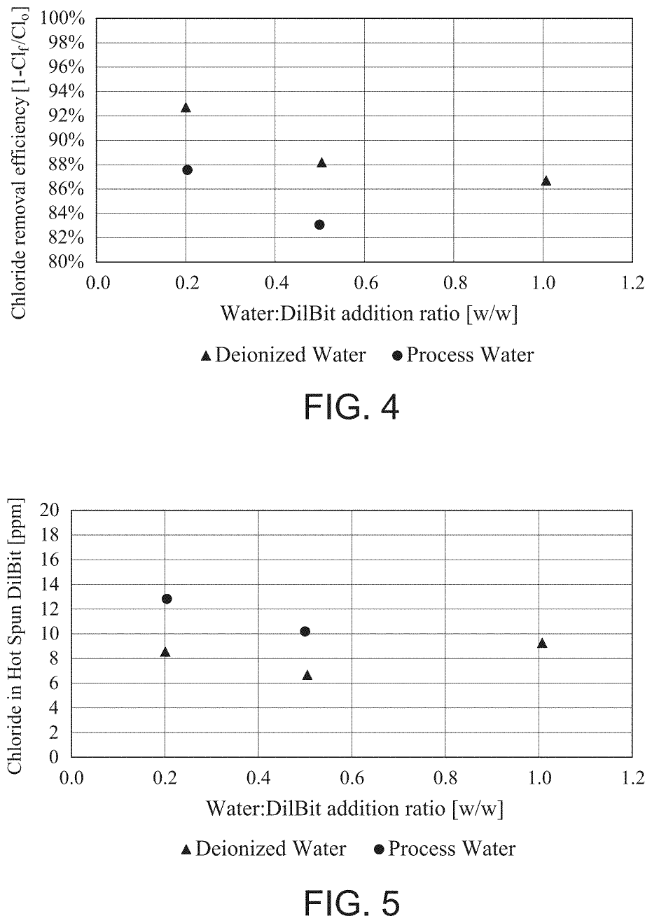

FIG. 4 shows that both deionized water and process water were able to remove a significant amount of chlorides from the raw diluted bitumen. As expected, the deionized water was more effective at removing chlorides, however, process water was still able to remove almost 88% of the chlorides at a water:dilbit addition ratio of 0.2 [w/w]. In general, there did not seem to be any significant beneficial effect of increasing wash ratios much past a water:dilbit addition ratio of 0.5.

FIG. 5 shows the chlorides (in ppm) present in the final diluted bitumen product after hot spin at 80° C. at the various water:dilbit addition ratios. It can be seen from FIG. 5 that with deionized water, at a water:dilbit addition ratio of 0.2, the ppm chlorides in the final product was about 8 ppm and at a water:dilbit addition ratio of 0.5, the chlorides were reduced even further to about 6.5 ppm. With process water, at a water:dilbit addition ratio of 0.2, the ppm chlorides in the final product was about 12.8 ppm and at a water:dilbit addition ratio of 0.5, the chlorides were reduced to about 10 ppm. Nevertheless, all tests with either deionized water or process water brought the product chloride contents below the target of ppm.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a method for processing bitumen froth comprised of bitumen, water containing chlorides and solids to produce a final diluted bitumen product having a reduced chlorides content, comprising, adding a sufficient amount of a naphtha diluent to the bitumen froth to form a diluted bitumen froth; subjecting the diluted bitumen froth to a first separation stage to separate a portion of the water and solids from the diluted bitumen froth to form a raw diluted bitumen; adding a sufficient amount of low salinity water to the raw diluted bitumen and subjecting the raw diluted bitumen to a mixing stage; optionally adding a sufficient amount of a demulsifier to the raw diluted bitumen after the mixing stage; and subjecting the raw diluted bitumen to a second separation stage to produce the final diluted bitumen product having reduced chlorides;

Clause 2, the method of clause 1, wherein the first separation stage comprises using at least one gravity separation vessel;

Clause 3, the method of clause 2, wherein the at least one gravity separator is an inclined plate settler;

Clause 4, the method of clause 1, wherein the first separation stage comprises using a centrifuge including a decanter centrifuge;

Clause 5, the method of clauses 1-4, wherein the second separation stage comprises using a centrifuge including a disc stack centrifuge;

Clause 6, the method of clauses 1-5, wherein the mixing stage is a high intensity mixing stage;

Clause 7, the method of clauses 1-5, wherein the mixing stage comprises using an inline shear mixer;

Clause 8, the method of clauses 1-5, wherein the mixing stage comprises using a tank having an impeller;

Clause 9, the method of clauses 1-8, wherein there is about a 90% or greater reduction in chlorides in the final diluted bitumen product;

Clause 10, the method of clauses 1-9, wherein the mixing stage imparts a specific energy dissipation of at least 2 kW/m³ or greater;

Clause 11, the method of clauses 1-9, wherein the mixing stage imparts a specific energy dissipation of at least 20 kW/m³ or greater;

Clause 12, the method of clauses 1-9, wherein the mixing stage imparts a specific energy dissipation of between about 2 kW/m³ to about 20 kW/m³;

Clause 13, the method of clauses 1-12, wherein demulsifier is added at a dosage in the range of about 1 ppm to about 50 ppm;

Clause 14, the method of clause 1, wherein the first separation stage comprises using at least one hydrocyclone.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

1. A method for processing bitumen froth comprised of bitumen, water containing chlorides and solids to produce a final diluted bitumen product having a reduced chlorides content, comprising:
(a) adding a sufficient amount of a naphtha diluent to the bitumen froth to form a diluted bitumen froth;
(b) subjecting the diluted bitumen froth to a first separation stage to separate a portion of the water and solids from the diluted bitumen froth to form a raw diluted bitumen;
(c) adding a sufficient amount of low salinity water to the raw diluted bitumen and subjecting the raw diluted bitumen to a mixing stage;
(d) optionally adding a sufficient amount of a demulsifier to the raw diluted bitumen after the mixing stage; and
(e) subjecting the raw diluted bitumen to a second separation stage to produce the final diluted bitumen product having reduced chlorides.

2. The method of claim 1, wherein the first separation stage comprises using at least one gravity separation vessel.

3. The method of claim 2, wherein the at least one gravity separator is an inclined plate settler.

4. The method of claim 1, wherein the first separation stage comprises using a centrifuge including a decanter centrifuge.

5. The method of claim 1, wherein the second separation stage comprises using a centrifuge including a disc stack centrifuge.

6. The method of claim 1, wherein the mixing stage is a high intensity mixing stage.

7. The method of claim 1, wherein the mixing stage comprises using an inline shear mixer.

8. The method of claim 1, wherein the mixing stage comprises using a tank having an impeller.

9. The method of claim 1, wherein there is about a 90% or greater reduction in chlorides in the final diluted bitumen product.

10. The method of claim 1, wherein the mixing stage imparts a specific energy dissipation of at least 2 kW/m³ or greater.

11. The method of claim 1, wherein the mixing stage imparts a specific energy dissipation of at least 20 kW/m³ or greater.

12. The method of claim 1, wherein the mixing stage imparts a specific energy dissipation of between about 2 kW/m³ to about 20 kW/m³.

13. The method of claim 1, wherein demulsifier is added at a dosage in the range of about 1 ppm to about 50 ppm.

14. The method of claim 1, wherein the first separation stage comprises using at least one hydrocyclone.
